(19) United States
(12) Patent Application Publication
(10) Pub. No.: US 2008/0287159 A1
(43) Pub. Date: Nov. 20, 2008

(54) COMMUNICATING WITH VISIBLE PERSON

(76) Inventors: Ronit Goldman, Kochav Yair (IL); Nir Goldman, Kochav Yair (IL)

Correspondence Address: David Klein;DEKEL PATENT LTD., Beit HaRof'im, 18 Menuha VeNahalu Street, Room 27, REHOVOT, IL

(21) Appl. No.: 11/747,942

(22) Filed: May 14, 2007

(51) Int. Cl. H04M 1/00

(52) U.S. Cl. 455/556.1

(57) ABSTRACT

A method including a seeking person pointing a directed energy transceiver in a communication device towards a sought person, the seeking and sought persons subscribing to a database in which all subscribers are equipped with means to transmit, receive, accept and reject directed energy signals, and the seeking person receiving a signal back from the sought person that enables the seeking person to communicate with the sought person according to personalized, predefined definitions for the subscribers.

### FIELD OF THE INVENTION

The present invention relates to the field of wireless communications systems, and more particularly to methods for communicating with a visible user, such as a wireless communication user.

### BACKGROUND OF THE INVENTION

Methods are known for locating a cellular telephone (cell phone) user, such as for law enforcement or emergency purposes. For example, U.S. Pat. No. 6,292,665 to Hildebrand et al. describes a method for geolocating a cell phone initiating an emergency call. However, this method is based on a base station transceiver that transmits a supervisory audio tone (SAT), which is automatically looped back by the calling cell phone. Returned SAT signals are correlated with those transmitted to determine the range of the cellular phone. In addition, incoming signals from the cellular phone, such as the returned SAT signals, are received by a phased array antenna and subjected to angle of arrival processing to determine the direction of the cellular phone relative to the base station. The cellular phone is geolocated based upon the angle of arrival and the range information. A correction factor provided by the manufacturer of a given cellular telephone is used to account for the loopback path delay through the phone.

One additional area in which wireless device location can be important is in wireless networks, such as wireless local area networks (WLANs) or wide area networks (WANs), for example. A typical prior art approach to locating terminals within a WLAN includes locating a plurality of receivers at fixed locations within a building, for example, and then determining (e.g., triangulating) the position of a terminal based upon a signal received therefrom at each of the receivers.

Another prior art approach for wireless terminal location is to use a direction finding (DF) device which includes a directional antenna for receiving signals when pointed in the direction of a transmitting node. An example of a portable DF device for WLANs is the Yellowjacket 802.11a Wi-Fi analysis system from Berkeley Varitronics. This device uses a passive DF technique, i.e., it does not solicit any signals from a terminal but instead waits for the terminal to transmit signals before it can determine the direction of the transmission.

Despite the advantages of such prior art wireless communications device locators, additional wireless location features may be desirable in various applications.

### SUMMARY OF THE INVENTION

The present invention seeks to provide methods for communicating with a visible user, e.g., a wireless communication user, as is described in more detail hereinbelow.

There is thus provided in accordance with an embodiment of the present invention a method including a seeking person pointing a directed energy transceiver towards a sought person, the seeking and sought persons subscribing to a database (that is, a service) in which all subscribers are equipped with means to transmit, receive, accept and reject directed energy signals. The seeking person sends a directed energy signal to the sought person, and receives a signal back from the sought person that enables the seeker to communicate with the sought person. The enabled communication (e.g., hidden or known cell phone number, SMS, etc.) is according to personalized, predefined definitions for the subscribers. For example, the sought person may send back the seeking person personal information, such as but not limited to, a wireless ID, cell phone number, email address, home address, etc., or any combination thereof. If the seeking person receives more than one signal back, the person with the strongest signal received back at the seeking person's transceiver will be considered as the sought person and provide the desired information.

After obtaining the cell phone number (hidden or known) of the sought person, the seeking person may call the sought person. Additionally or alternatively, after obtaining the cell phone number of the sought person, a text message may be automatically sent to the sought person. The seeking person, if authorized, may obtain a name of the sought person from the database.

### BRIEF DESCRIPTION OF THE DRAWINGS

The present invention will be understood and appreciated more fully from the following detailed description taken in conjunction with the drawings in which:

FIG. 1 is a simplified flow chart of a method for communicating with a visible wireless communication user (e.g., a cell phone user), in accordance with an embodiment of the present invention; and

FIG. 2 is a simplified flow chart of a method for communicating with a visible wireless communication user (e.g., a cell phone user), in accordance with another embodiment of the present invention.

### DETAILED DESCRIPTION OF EMBODIMENTS

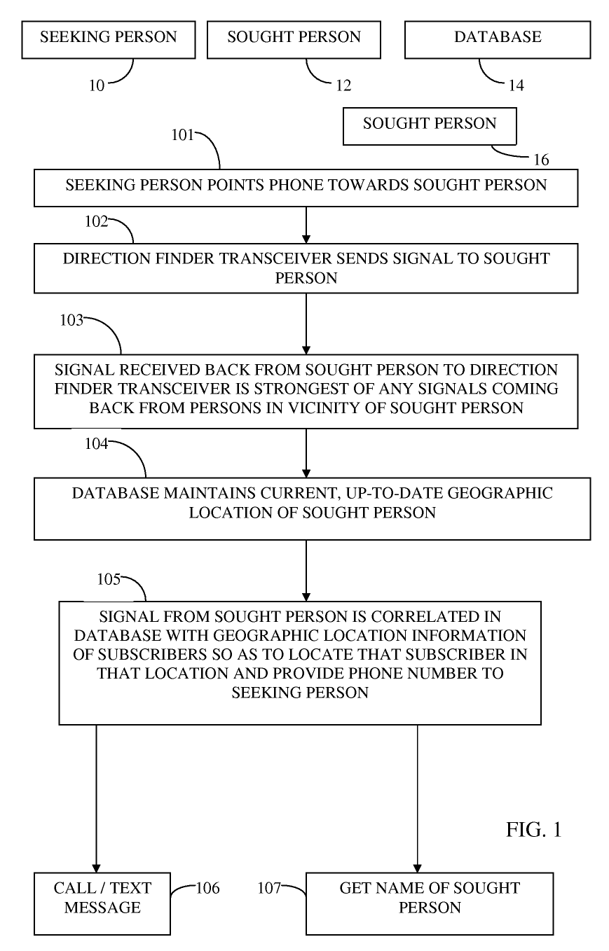

Reference is now made to FIG. 1, which illustrates a method for communicating with a visible wireless communication user, in accordance with an embodiment of the present invention. Communication is carried out with any communication device, such as but not limited to, wireless communication devices (cell phone, PDA, portable multimedia player (PMP), etc.) or even wired communication devices (telephone and the like). The invention will be described using a cell phone, but it is appreciated that the invention is not limited to a cell phone, rather any communication device.

The method involves at least one seeking person 10 and at least one sought person 12. In one example, the seeking person may be a male/female at a barroom or park and such, and the sought person may be a female/male in the same barroom or park and such. The applications of the invention are limitless.

The method also requires that both the seeking person 10 and the sought person 12 are members of (e.g., subscribe to) a database 14 which is a service in which the cell phone number (or any other means of communicating with the sought person) of the sought person is stored. As subscribers to the database 14, the sought person 12 has given his/her permission for supplying certain personal information to the seeking person 10 upon request. The seeking person's communication device is equipped with a directed energy transceiver 16, which transmits a signal towards the sought person, receives a signal back from the sought person. Directed energy transceiver 16 may be a direction finder transceiver (the terms being used interchangeably). As is known in the art of direction finding, directed energy transceiver 16 may include an antenna that is directional, being more sensitive in narrow angle. The sought person's communication device is also equipped with a transceiver 16 that can receive the signal from the seeking person 10 and cause transmission of information to the seeking person 10 as is described hereinbelow.

The seeking person 10 may point his/her cell phone towards the sought person 12 (101) and the directed energy transceiver 16 sends a signal to the sought person 12 (102).

If the seeking person 10 and the sought person 12 subscribe to database 14, the signal sent to the sought person 12 causes the cell phone of the sought person 12 to send personal information to the seeking person 10 (103). The enabled communication (e.g., hidden or known cell phone number, SMS, etc.) is according to personalized, predefined definitions for the subscribers. For example, the sought person may send back the seeking person with personal information, such as but not limited to, a communication ID, cell phone number, email address, home address, etc. The personal information may be sent by the same mode of communication as the signal from the directed energy transceiver 16 (e.g., RF, infrared, Bluetooth, etc.) (104), or by a different mode of communication (cellular, Internet, etc.) (105). If the seeking person receives more than one signal back, the person with the strongest signal received back at the seeking person's transceiver will be considered as the sought person and provide the desired information (106).

Optionally, the database 14 may maintain a current, up-to-date geographic location of the sought person 12 (107). The current technology of cell phone service providers can easily provided this information, such as by means of GPS or other equivalent technology, in which the current position of the cell phone user is correlated to that person's cell phone number. The signal from the sought person 12 (the strongest signal received back at transceiver 16) is correlated in the database 14 with the geographic location information of the subscribers so as to locate that subscriber in that location and provide his/her phone number to the seeking person 10 (108).

After obtaining the back signal of the sought person, the seeking person may communicate with the sought person according to a personalized predefined authorization of the sought person. Examples may include calling the sought person, after obtaining his/her cell phone number, automatically sending a text message to the sought person, or obtaining the name of the sought person from the database etc.

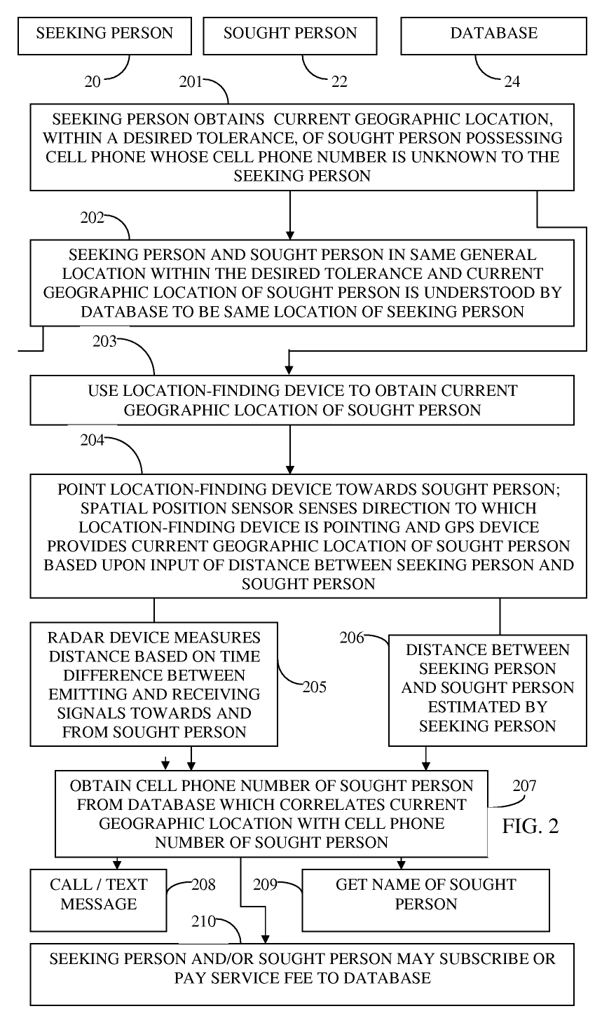

Reference is now made to FIG. 2, which illustrates a method for communicating with a visible cell phone user, in accordance with another embodiment of the present invention.

The method involves at least one seeking person 20 and at least one sought person 22. In one example, the seeking person may be a male/female at a barroom or park and such, and the sought person may be a female/male in the same barroom or park and such. In another example, the seeking person may be a law enforcement agent on a street and the visible sought person may be a wanted fugitive whose facial or other physical identity is known to the law enforcement agent and who is in sighting distance from the law enforcement agent. The applications of the invention are limitless.

The method also requires a database 24 in which communication ID of the sought person is stored and which maintains a current, up-to-date geographic location of the sought person. The current technology of cell phone service providers, for example, can easily provided this information, such as by means of GPS or other equivalent technology, in which the current position of the cell phone user is correlated to that person's cell phone number.

The seeking person may obtain a current geographic location, within a desired tolerance, of the sought person possessing a communication device (e.g., cell phone) whose communication ID (e.g., cell phone number) is unknown to the seeking person (201). For example, in accordance with one embodiment of the invention, the seeking person and the sought person may be in the same general location within the desired tolerance (e.g., near each other in the same room or sitting next to each other on a bus, train or airplane) and the current geographic location of the sought person is understood by the database to be the same location of the seeking person (202), either by default or by the seeking person making such an indication to the database. In such an example, the seeking person does not need to point his/her cell phone towards the sought person.

In accordance with another embodiment of the invention, the seeking person may use a location-finding device to obtain the current geographic location of the sought person (203). The location-finding device may include a global position system (GPS) device and a spatial position sensor, the spatial position sensor being capable of sensing a direction to which the location-finding device is pointed. The seeking person may point his/her cell phone with the location-finding device (or just the location-finding device if it is separate from the cell phone) towards the sought person, wherein the spatial position sensor senses the direction to which the location-finding device is pointing and the GPS device provides the current geographic location of the sought person within the desired tolerance based upon an input of a distance between the seeking person and the sought person (204). Of course, direction finder transceiver 16 may also be used in this embodiment for direction finding.

One way of inputting the distance between the seeking person and the sought person is by providing the wireless communication device of the seeking person with a radar device that measures this distance based on a time difference between emitting and receiving signals towards and from the sought person (205). Any other suitable direction finding apparatus may be used to carry out the invention as well.

Alternatively, the distance between the seeking person and the sought person may be estimated by the seeking person and input to the database (206).

The database processes the request and geographic information so that the seeking person, by communicating with the database, obtains the wireless communication ID (i.e. cell phone number) of the sought person, wherein the database correlates the current geographic location with the communication ID (e.g., cell phone number) of the sought person (207).

After obtaining the wireless communication ID (e.g., cell phone number) of the sought person, the seeking person may call the sought person. Additionally or alternatively, after obtaining the cell phone number of the sought person, a text message may be automatically sent to the sought person (208). The seeking person, if authorized, may obtain a name of the sought person from the database (209).

The seeking person and/or the sought person may subscribe to the database (210). The seeking person and/or the sought person may pay a service fee to a managing entity of the database (210).

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method comprising:
a seeking person pointing a directed energy transceiver in a communication device towards a sought person, the seeking and sought persons subscribing to a database in which all subscribers are equipped with means to transmit, receive, accept and reject directed energy signals; and
the seeking person receiving a signal back from the sought person that enables the seeking person to communicate with the sought person according to personalized, predefined definitions for the subscribers.

2. The method according to claim 1, wherein the sought person sends back the seeking person personal information.

3. The method according to claim 2, wherein the personal information comprises at least one of a communication ID, a cell phone number, an email address, and a home address.

4. The method according to claim 1, wherein if the seeking person receives more than one signal back, the person with the strongest signal received back at the seeking person's transceiver is considered as the sought person.

5. A method comprising:
a seeking person obtaining a current geographic location, within a desired tolerance, of a sought person possessing a wireless communicating device; and
obtaining the communication ID of the sought person by communicating with a database in which the communication ID of the sought person is stored and which maintains a current, up-to-date geographic location of said sought person, wherein said database correlates said current geographic location with the cell phone number of the sought person.

6. The method according to claim 5, wherein the seeking person and the sought person are in the same general location within the desired tolerance and the current geographic location of the sought person is understood by the database to be close to the location of the seeking person.

7. The method according to claim 5, further comprising using a location-finding device to obtain the current geographic location of the sought person.

8. The method according to claim 7, wherein said location-finding device comprises a global position system (GPS) device and a spatial position sensor, said spatial position sensor being capable of sensing a direction to which said location-finding device is pointed, and the method comprises pointing said location-finding device towards the sought person, wherein said spatial position sensor senses the direction to which said location-finding device is pointing and said GPS device provides said current geographic location of the sought person within the desired tolerance based upon an input of a distance between the seeking person and the sought person.

9. The method according to claim 5, further comprising communicating with the sought person after obtaining the communication ID of the sought person.

10. The method according to claim 5, wherein at least one of the seeking person and the sought person subscribes to the database.

11. The method according to claim 5, wherein at least one of the seeking person and the sought person are members of a service managing said database.

12. The method according to claim 5, further comprising obtaining authorized information of the sought person from the database.
